(19) United States
(12) Patent Application Publication
(10) Pub. No.: US 2006/0209643 A1
(43) Pub. Date: Sep. 21, 2006

(54) Optical scanning device

(75) Inventor: Johannes Joseph Hubertina Barbara Schleipen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., 5621 BA Eindhoven (NL)

(21) Appl. No.: 10/552,810

(22) PCT Filed: Apr. 5, 2004
(86) PCT No.: PCT/IB04/50396

§ 371 Date: Oct. 11, 2005

(30) Foreign Application Priority Data
Apr. 14, 2003 (EP) 03100998.8

(51) Int. Cl. G11B 7/00

(52) U.S. Cl. 369/44.23

(57) ABSTRACT

The invention relates to an optical scanning device and to an optical wavefront modifier for use therein, for scanning an optical record carrier, such as an optical disk comprising an information layer. The device comprises a radiation source (9) for emitting an incident radiation beam; a detection system comprising an information signal detector (25) arranged to receive radiation reflected from the information layer and to detect an information signal therein; an optical system (14, 12) for focusing the incident radiation beam to a spot on in the record carrier, and for directing the reflected radiation beam onto the information signal detector; and an optical wavefront modifier (10) arranged in the path of the incident radiation beam and the reflected radiation beam. The incident radiation beam has a first wavefront shape at a given location (L) prior to its incidence on the optical wavefront modifier and the reflected radiation beam has a second wavefront shape at the given location after passing through the optical wavefront modifier. In embodiments of the invention, the optical wavefront modifier is arranged to perform wavefront modification on the incident and reflected radiation beams such that the second wavefront shape is substantially different to the first wavefront shape. The second wavefront shape is of such a form that the optical path of the reflected radiation beam is less than the optical path of the incident radiation beam so that the optical scanning device can be further miniaturised.

This invention relates to an optical scanning device and to an optical wavefront modifier for use therein, for scanning an optical record carrier, such as an optical disk comprising an information layer. The device comprises a radiation source for emitting an incident radiation beam; a detection system comprising an information signal detector arranged to receive radiation reflected from the information layer and to detect an information signal therein; and an optical system for focusing the incident radiation beam to a spot on in the record carrier, and for directing the reflected radiation beam onto the information signal detector.

In the field of optical disc technology, improving performance, increasing miniaturization, simplification and reliability, and reducing costs associated with the optical scanning device are all important desiderata

When addressing the problem of miniaturization, companies have looked to the field of semiconductor technology, which is renowned for its ability to generate a significant amount of functionality in a very small space. For example, as a light source for digital video disc playback, companies have developed a low-noise red semiconductor laser diode; and two-wavelength CD laser couplers, which are essentially two lasers integrated on a single chip, have been developed to solve the space problem associated with dual wavelength radiation sources. Both of these developments have served as a significant breakthrough in miniaturization and cost reduction of optical scanning devices, and many companies have since developed alternatives to, and improvements on, these semiconductor devices. However, miniaturization of optical scanning devices is ultimately constrained by properties of the radiation used to scan the disc and components that are required to direct the radiation to a particular location on an optical disk (i.e. the optical path of the radiation). For example, the focal length and numerical aperture of the collimator lens are mainly determined by fixed system choices such as objective lens pupil diameter and rim intensities, which cannot be changed easily. As a result the distance between the radiation source and collimator lens is also fixed. Thus, however small the radiation source becomes, the size of the optical pickup device is constrained by optical path requirements.

It would be desirable if the optical path could be modified in such a way as to occupy less space.

According to a first aspect of the present invention there is provided an optical scanning device for scanning an optical record carrier comprising an information layer, the device comprising:

a radiation source for emitting an incident radiation beam;

a detection system comprising an information signal detector arranged to receive radiation reflected from the information layer and to detect an information signal therein;

an optical system for focusing the incident radiation beam to a spot on in the record carrier, and for directing the reflected radiation beam onto the information signal detector; and

an optical wavefront modifier arranged in the path of the incident radiation beam and the reflected radiation beam,

wherein the incident radiation beam has a first wavefront shape at a given location prior to its incidence on the optical wavefront modifier and the reflected radiation beam has a second wavefront shape at the said given location after passing through the optical wavefront modifier,

characterised in that the optical wavefront modifier is arranged to perform wavefront modification on the incident and reflected radiation beams such that the second wavefront shape is substantially different to the first wavefront shape.

In embodiments of the invention, the wavefront modification is such that the optical path length between the information layer and the information signal detector is less than the optical path length between the radiation source and the information layer. Preferably, the distance between the detector and a beam splitter component is less than half the distance between the radiation source and the beam splitter component. Thus in preferred embodiments, the shape of the reflected radiation wavefront, for the purposes of signal detection, is modified earlier than it is in conventional arrangements, which means that the optical scanning device occupies less space than is required by conventional devices.

Conveniently the optical wavefront modifier is arranged to provide a focus servo wavefront modification, which is arranged to generate a focus servo signal at the detection system. In one arrangement, the optical wavefront modifier is arranged to provide an astigmatic wavefront modification, preferably by means of a cylindrical lens. In a second arrangement, the optical wavefront modifier is arranged to split the reflected radiation beam into two sub beams, thereby providing a beam splitting wavefront modification Preferably, such a wavefront modification is provided by either a double wedge structure or a grating.

The optical wavefront modifier is also arranged to provide a focusing wavefront modification, which is arranged to at least partly focus the reflected radiation beam onto the detection system. When the optical wavefront modifier is arranged to split the reflected radiation beam into two sub beams, the focusing wavefront modification may be provided by a curved surface along at least part of a surface of the optical wavefront modifier.

Advantageously the optical wavefront modifier comprises a birefringent structure whose refractive index varies in accordance with the polarization of radiation passing therethrough. The optical wavefront modifier thus varies the optical path of an incoming beam in dependence on the polarization of the incoming beam. In embodiments of the invention, the optical wavefront modifier is arranged to apply zero modification to the incident radiation beam, so that the incident radiation beam is unaffected by the optical wavefront modifier. Preferably, the optical wavefront modifier is positioned in a collimated portion of the incident radiation beam.

Further objects, advantages and features of the invention will be apparent from the following more particular description of preferred embodiments of the invention, as illustrated in the accompanying drawings, in which:

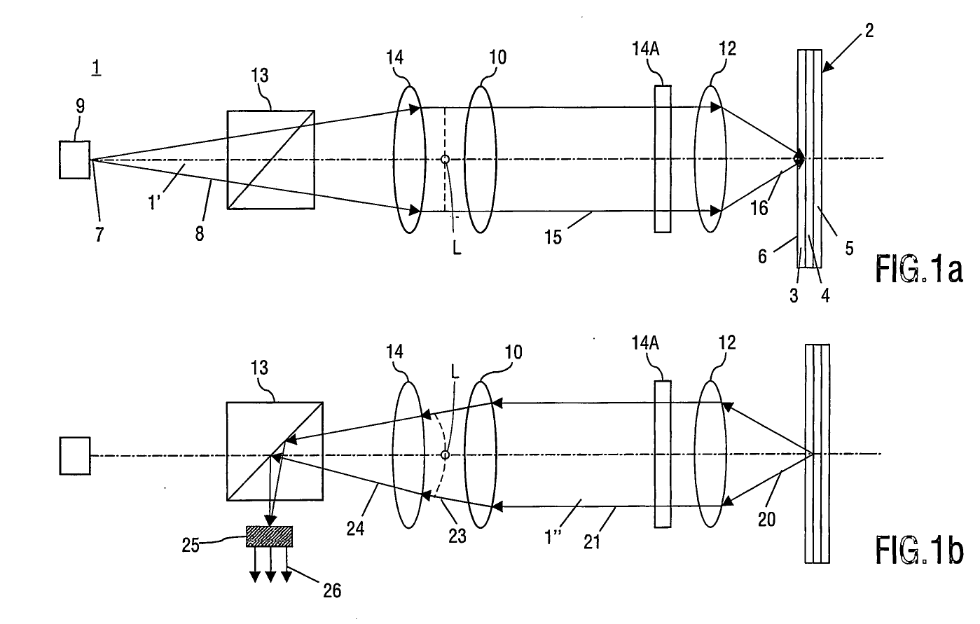

FIG. 1a is a schematic diagram showing the pathway of incident light generated by a scanning device according to a first embodiment of the invention;

FIG. 1b is a schematic diagram showing the pathway of reflected light generated by a scanning device according to the first embodiment of the invention;

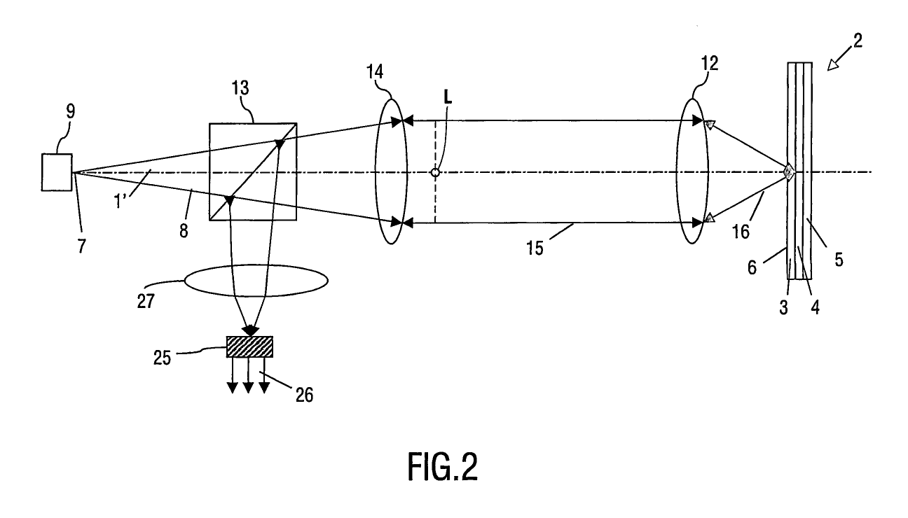

FIG. 2 is a schematic diagram showing the pathways of incident and reflected light according to conventional arrangements;

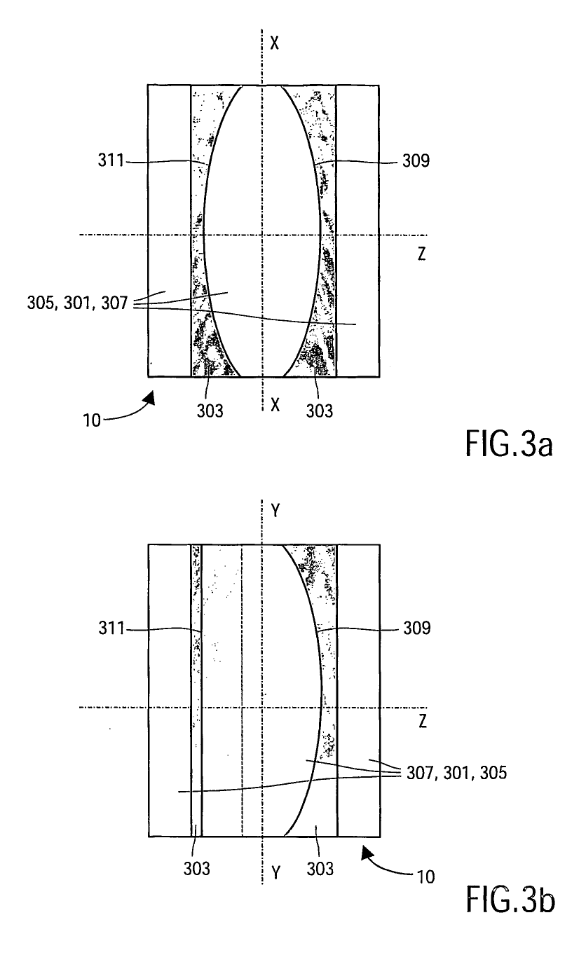

FIG. 3a shows a cross section through line X-X of an optical wavefront modifier, including a liquid crystal structure, according to the embodiment shown in FIGS. 1a and 1b;

FIG. 3b shows a cross section through line Y-Y of an optical wavefront modifier, including a liquid crystal structure, according to the embodiment shown in FIGS. 1a and 1b;

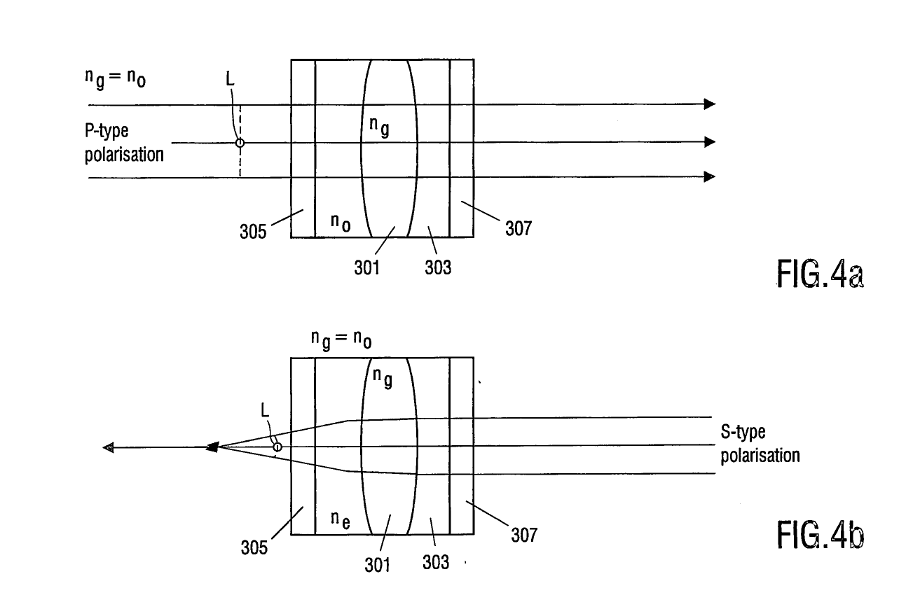

FIG. 4a is a schematic diagram showing the optical pathway, through the optical wavefront modifier of FIGS. 3a and 3b, of a beam that is polarised along an axis perpendicular to the optical axis of the liquid crystal structure shown in FIGS. 3a and 3b;

FIG. 4b is a schematic diagram showing the optical pathway, through the birefringement optical wavefront modifier of FIGS. 3a and 3b, of a beam that is polarised along an axis parallel to the optical axis of the liquid crystal structure shown in FIGS. 3a and 3b;

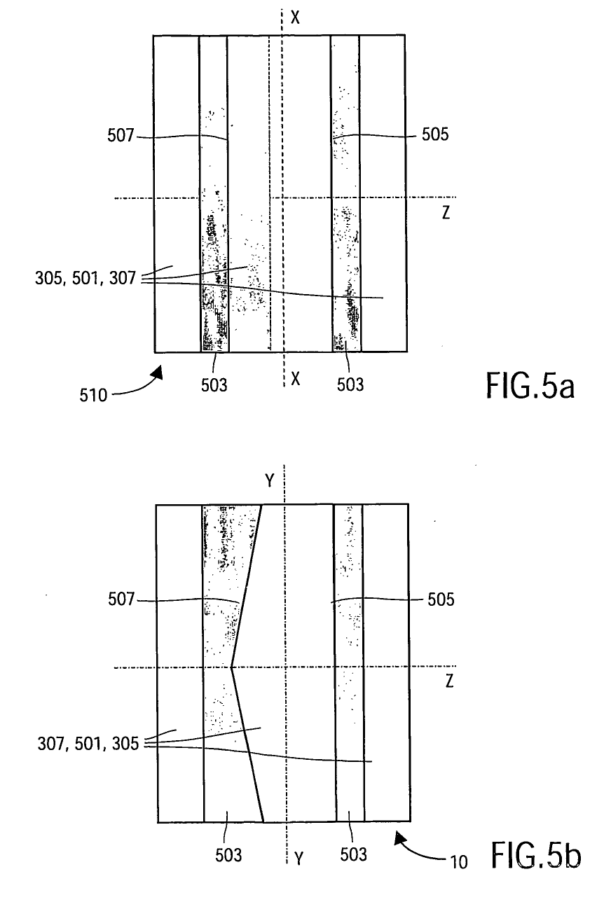

FIG. 5a shows a cross section through line X-X of an optical wavefront modifier, including a liquid crystal structure, according to a second embodiment of the invention;

FIG. 5b shows a cross section through line Y-Y of an optical wavefront modifier, including a liquid crystal structure, according to a second embodiment of the invention;

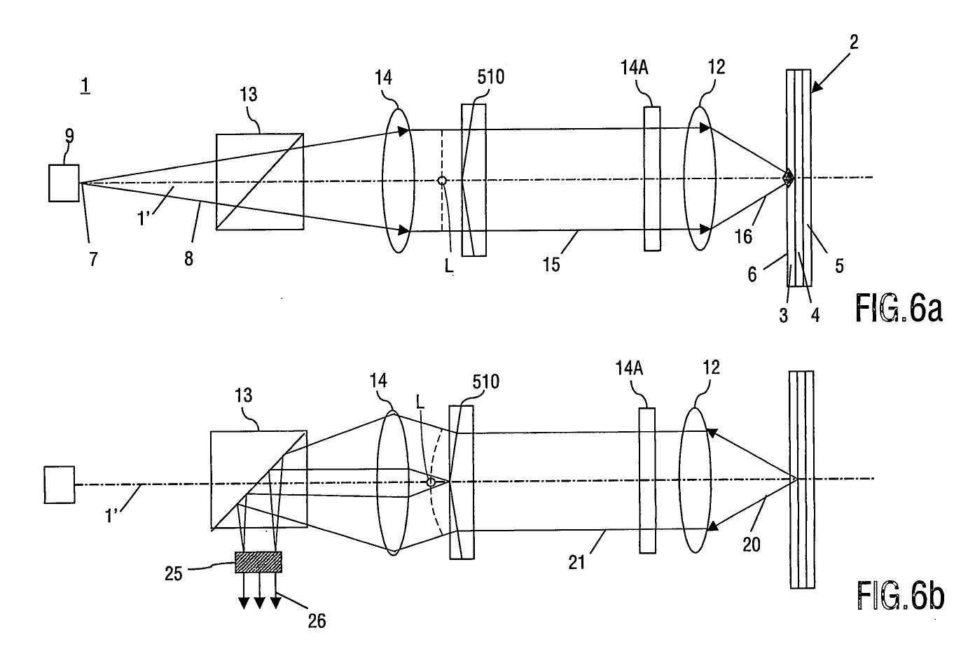

FIG. 6a is a schematic diagram showing the pathway of incident light generated by a scanning device according to a second embodiment of the invention;

FIG. 6b is a schematic diagram showing the pathway of reflected light generated by a scanning device according to the second embodiment of the invention;

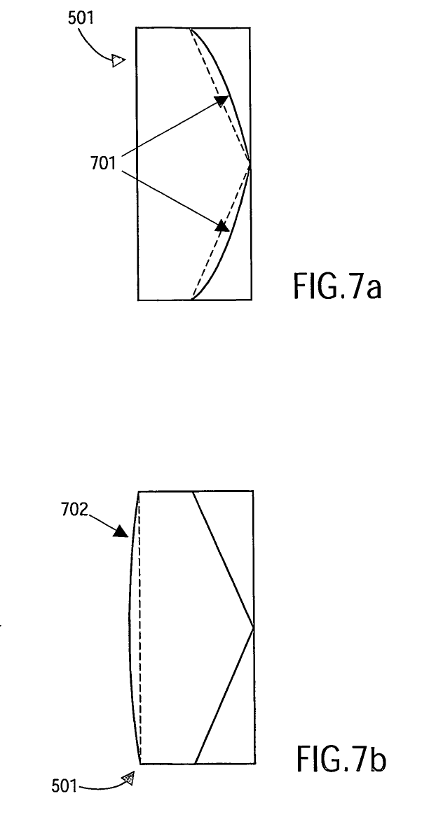

FIGS. 7a and 7b are schematic diagrams showing further aspects of the optical wavefront modifier according to the second embodiment; and

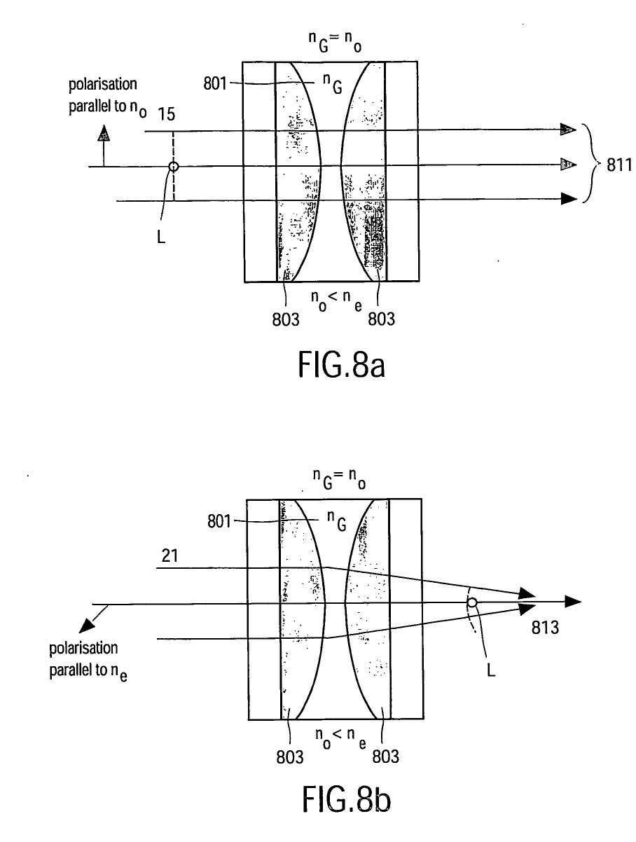

FIGS. 8a and 8b are schematic diagrams showing alternative configurations of the optical wavefront modifier according to the first embodiment, together with the optical pathway therethrough as a function of different beam polarisations.

FIGS. 1a and 1b show elements of an optical scanning device 1, arranged in accordance with an embodiment of the invention, including an optical head for scanning an optical record carrier 2. Referring firstly to FIG. 1a, the record carrier is in the form of an optical disk comprising a transparent layer 3, on one side of which an information layer 4 is arranged. The side of the information layer facing away from the transparent layer is protected from environmental influences by a protection layer 5. The side of the transparent layer facing the device is called the entrance face 6. The transparent layer 3 acts as a substrate for the record carrier by providing protective and/or mechanical support for the information layer. Information may be stored in the information layer 4 of the record carrier in the form of optically detectable marks arranged in substantially parallel, concentric or spiral tracks, not indicated in FIG. 1a The marks may be in any optically readable form, e.g. in the form of pits, or areas with a reflection coefficient or a direction of magnetisation different from their surroundings, or a combination of these forms.

The scanning device 1 comprises a radiation source in the form of a semiconductor laser 9 emitting a radiation beam 7. The radiation beam is used for scanning the information layer 4 of the optical record carrier 2. A beam splitter 13, in this example a polarising beam splitter transmitting P-type polarisation, transmits the diverging radiation beam 8 on optical path 1′ towards a collimator lens 14, which converts the diverging beam 8 into a substantially collimated beam 15. The device 1 also includes an optical wavefront modifier 10 and a polarzing rotating element 14A, located between the beam splitter 13 and optical record carrier 2. At a given location L, prior to incidence of the incident beam on the optical wavefront modifier, the wavefront of the incident radiation beam is substantially flat (since the incident radiation beam is collimated at location L). Aspects of the optical wavefront modifier are discussed in detail below.

An objective lens 12 is positioned in the path of the collimated beam 15, and transforms the collimated radiation beam 15 into a converging beam 16, which is focused to a spot on the information layer 4 being scanned. Polarisation rotating element 14A, which may be a quarter wavelength retarder plate, is interposed between the collimator lens 14 and the objective lens 12, and creates a 90° rotation in polarisation between the reflected and incident beams.

Referring now to FIG. 1b, the converging beam 16 is reflected by the information layer 4 and forms a diverging reflected beam 20, which returns along the optical path 1′ of the forward converging beam 16. The objective lens 12 transforms the reflected beam 20 to a substantially collimated reflected beam 21, whereupon it passes through the optical wavefront modifier 10. The optical wavefront modifier 10 modifies the shape of the wavefront of the reflected beam, transforming the collimated beam 21 into a converging beam 23. At the given location L, and because the reflected radiation beam is converging, the shape of the wavefront is now curved and includes a focus servo wavefront modification, which in this embodiment is astigmatic, and a focusing wavefront modification, which in this embodiment is spherical. Thus the shape of the reflected beam wavefront differs from that of the incident beam wavefront at the given location L.

Converging beam 23 passes through the collimator lens 14 and continues onto the beam splitter 13, which separates the forward and reflected beams by transmitting at least part of the further converged beam 24 towards a detection system 25. The detection system captures the radiation and converts it into electrical output signals 26 which are processed by signal processing circuits (not shown), and a derived focus error signal is used to adjust the position of the objective lens 12.

FIG. 2 shows a conventional optical scanning device, without optical wavefront modifier 10 and polarisation rotating element 14A. In such conventional arrangements, the focus servo lens 27 of the optical scanning device is separated from the optical path 1′ of the incident beam. It can be seen that, at the given location L, the shapes of the incident and reflected beam wavefronts are identical (flat), since at this location both radiation beams are collimated. Since the position of the detection system 25 is dependent on the optical characteristics of the reflected beam—conventionally dictated by objective lens 12, collimator lens 14 and focus servo lens 27—the detection system 25 is located substantially further from the optical path 1′ of the incident beam than is possible with embodiments of the invention.

FIGS. 3a and 3b respectively show cross-sections through lines X-X and Y-Y of a first embodiment of the optical wavefront modifier 10. The optical wavefront modifier 10 includes a birefringent material, such as a liquid crystal (LC) polymer. As is known in the art, a birefringent material has a refractive index which is dependent on the polarisation of the radiation passing through it In this example the optic axis of the birefringent material is arranged in the S-direction. If the polarisation of an incoming radiation beam is parallel to the optical axis of the liquid crystal (S-type), the refractive index of the birefringent material is nₑ (extraordinary mode); if perpendicular to the optic axis (P-type) then the refractive index is nₒ (ordinary mode). In this embodiment, the optical wavefront modifier 10 generates an astigmatic focused beam for use in an astigmatic focus servo system, and comprises a convex-convex sphero-cylindrical glass lens 301, embedded in birefringent material 303, which is positioned between an upper glass substrate 305 and a lower glass substrate 307. The lens 301 includes a convex spherical surface 309 and a convex cylindrical surface 311. The sphero-cylindrical glass lens 301 is non-birefringent, and has a refractive index of nₒ; consequently, when light having P-type polarization travels through the optical wavefront modifier 10, there is no change in refractive index as the light passes through the interface between the birefringent material 303 and the sphero-cylindrical glass lens 301. As a result incoming light of P-type polarization is not refracted as it passes through the optical wavefront modifier 10 of the first embodiment.

Since the diverging incident beam 7 first passes through the polarising beam splitter 13 transmitting P-type polarization, the optical wavefront modifier 10 applies a zero wavefront modification to the incident radiation beam, and the pathway corresponding to collimated beam 15 having P-type polarization is unaffected by the optical wavefront modifier 10, as shown in FIG. 4a.

Turning back go FIGS. 1a and 1b, having exited the optical wavefront modifier 10, the collimated beam 15 passes through the quarter wavelength plate 14A, which modifies the polarisation of the incident beam to a right-handed circular polarization. The collimated beam 15 is then converged by the objective lens 12 and reflected from the information layer 4, which causes the polarisation of the reflected beam to be modified to a left-handed circular polarization. When the reflected beam 21 passes through the quarter wavelength plate 14A, it is modified to an S-type polarisation.

Thus when the reflected beam 21, with an S-type polarization, enters the optical wavefront modifier 10, the refractive index of the birefringent material 303 is nₑ; since the refractive index of the sphero-cylindrical glass lens 201 is nₒ, and since the interface between the birefringent material 303 and the sphero—cylindrical glass lens 301 is non-planar, the optical wavefront modifier applies a non-zero wavefront modification to the reflected radiation beam, generating the curved wavefront shape, including an astigmatic wavefront modification and a spherical wavefront modification, at location L. The converging beam 23 subsequently passes through collimator lens 14, which further refracts the converging beam onto the detection system 25, as shown in FIG. 1b.

As the position of the detection system 25 is determined by the optical path 1″ of the reflected beam, earlier refraction of the collimated beam 21 into a form suitable for signal detection (here a converged astigmatic beam) means that the detector 25 can be moved closer to the optical path 1′ of the incident beam, thereby reducing the size of the optical scanning device.

A second embodiment will now be described with reference to FIGS. 5a and 5b; features common to both embodiments are referred to by reference numerals used in the first embodiment, and are not described in any further detail.

Referring to FIGS. 5a and 5b, the optical wavefront modifier 510 is arranged to provide a beam-splitting wavefront modification, generating two sub-beams in accordance with the Focault focusing method. In this particular arrangement, the optical wavefront modifier incorporates a double wedge plate (or a grating) 501, embedded in birefringent material 503. The double wedge plate 501 includes a planar surface 505 and a set of wedge surfaces 507. The birefringent material 503 is positioned between an upper glass substrate 305 and a lower glass substrate 307, and, as for the first embodiment, its optic axis is assumed to be arranged in the S-direction. The wedge plate 501 is non-birefringent, and has a refractive index of nₒ; consequently, when light having P-type polarization passes through the optical wavefront modifier 510, there is no change in refractive index as the light leaves the birefringent material 503 and enters the wedge plate 501. Thus, as for the first embodiment, incident radiation of P-type polarization is not refracted as it passes through the optical wavefront modifier 510 (FIG. 6a). Once it has been reflected by the information layer 4 however, the reflected beam 21 is of S-type polarization, and, as shown in FIG. 6b, is refracted as it passes through the optical wavefront modifier 510. As a result, at the given location L, the wavefront shape of the reflected radiation beam comprises two sub-beams; as for the first embodiment, this differs from the wavefront shape at location L of the incident radiation beam.

Note that, in the embodiment shown in FIGS. 5a and 5b the rear plate 307 and the adjacent birefringent layer may be omitted.

In an alternative embodiment, the optical wavefront modifier 510 additionally includes means for focusing the beam 23 onto the detector 25. Referring to FIGS. 7a and 7b, the wedge structure 501 could be modified to include a set of curved surfaces or a grating 701 on the wedge surfaces, as shown in FIG. 7a and/or a spherical surface 702 on the opposite surface, as shown in FIG. 7b, to provide a focusing function.

Whilst in the astigmatic embodiments described above, the lens 301 is a convex-convex sphero-cylindrical lens, it may alternatively be concave-concave sphero-cylindrical lens, as shown in FIGS. 8a and 8b (Note that in FIG. 8b the reflected beam is shown traveling from left to right (contrary to earlier figures)). As for the first embodiment, if the polarisation of the radiation beam is parallel to the optical axis of the liquid crystal, the refractive index of the birefringent material is ne; if perpendicular to the optic axis then the refractive index is nₒ. Thus turning to FIG. 8a, when light having polarization perpendicular to the optic axis travels through the optical wavefront modifier 10, there is no change in refractive index and the light remains collimated 811 as it passes through the optical wavefront modifier 10. When light having polarization parallel to the optic axis travels through optical wavefront modifier 10, there is a change in refractive index of the optical wavefront modifier: in the arrangement shown in FIG. 8b, the refractive index of the birefringent structure 803 is higher than that of the focusing lens 301 (since nₑ>nₒ), and shape of the reflected beam wavefront is modified as it passes through the interface between the birefringent structure 803 and the focusing lens 801. At the given location L it can again be seen that, in comparison to the shape of the incident beam wavefront, the reflected beam wavefront is curved and includes an astigmatic wavefront modification and a spherical wavefront modification.

In preferred embodiments, the optical wavefront modifier comprises features providing combined focus servo lens and a focusing functionality. As an alternative, the optical wavefront modifier could provide a focusing functionality only, with the focus servo functionality being provided by a suitable focus servo lens component positioned between the detection system 25 and the beam splitter 13. Whilst this is not a preferred arrangement, because such a focus servo component occupies space between the beam splitter and the detector 25, the arrangement nevertheless offers a reduction in space required compared to conventional detection systems, because focusing of the reflected beam is stronger than is currently possible with conventional optical scanning systems, allowing the detector 25 to be located closer to the beam splitter 13, for example less than half the distance from the source 9 to the beam splitter 13.

As a further alternative, if, the radiation source 7 were located sufficiently close to the beam splitter so that the collimator 14 alone could focus the reflected beam onto the detector 25 when located equally closer, the optical wavefront modifier 10 could omit the focusing functionality and just include the focus servo lens functionality.

Whilst in the embodiments described above, the collimator lens 14 is positioned between the beam splitter 13 and the optical wavefront modifier, so that it affects both the incident beam and the reflected beam, it may alternatively be located between the radiation source 9 and the beam splitter 13, thereby only affecting the path of incident beam 7. In this case, the optical wavefront modifier, together with the beam splitter 13, are solely responsible for directing the collimated reflected beam 21 onto the detector 25; in the case of the first embodiment, this means that the spherical profile of the wavefront modifier should have stronger focusing properties than that used in the previously-described arrangement

The above embodiments are to be understood as illustrative examples of the invention. Further embodiments of the invention are envisaged. For example, whilst in the above embodiments the optical wavefront modifier is located in a collimated part of the beams, the modifier may for example be placed in an uncollimated part of the beam, such that the described wavefront shape at the given location in the incident beam is, for example, spherical. Note that the term “different” when applied to wavefront shapes includes for example two spherical wavefronts having different radii of curvature. Also, whilst in the above embodiments the optical wavefront modifier includes two functions, namely focus servo wavefront modification and focusing wavefront modification, in a single birefringent element, the two functions may be provided in two separate birefringent elements. It is to be understood that any feature described in relation to one embodiment may also be used in other of the embodiments. Furthermore, equivalents and modifications not described above may also be employed without departing from the scope of the invention, which is defined in the accompanying claims.

1. An optical scanning device (1) for scanning an optical record carrier (2) comprising an information layer (4), the device comprising:
a radiation source (9) for emitting an incident radiation beam (7);
a detection system comprising an information signal detector (25) arranged to receive radiation reflected from the information layer and to detect an information signal therein;
an optical system (14, 12) for focusing the incident radiation beam to a spot on in the record carrier, and for directing the reflected radiation beam onto the information signal detector; and
an optical wavefront modifier (10) arranged in the path of the incident radiation beam and the reflected radiation beam,
wherein the incident radiation beam has a first wavefront shape at a given location prior to its incidence on the optical wavefront modifier and the reflected radiation beam has a second wavefront shape at the said given location after passing through the optical wavefront modifier,
characterised in that the optical wavefront modifier is arranged to perform wavefront modification on the incident and reflected radiation beams such that the second wavefront shape is substantially different to the first wavefront shape.

2. A device according to claim 1, wherein the optical path length between the information layer and the detection system is less than the optical path length between the radiation source and the information layer.

3. A device according to claim 1, wherein the optical wavefront modifier is arranged to provide a focus servo wavefront modification which is arranged to generate a focus servo signal at the detection system.

4. A device according to claim 3, wherein the optical wavefront modifier is arranged to provide an astigmatic wavefront modification.

5. A device according to claim 3, wherein the optical wavefront modifier is arranged to split the reflected radiation beam into two sub beams, thereby providing a beam splitting wavefront modification.

6. A device according to claim 1, wherein the optical wavefront modifier is arranged to provide a focusing wavefront modification which is arranged to at least partly focus the reflected radiation beam onto the detection system.

7. A device according to claim 6, wherein the optical wavefront modifier includes a double wedge structure having a profile (601, 602) along at least part of a surface thereof.

8. A device according to claim 1, wherein the optical wavefront modifier comprises a birefringent part (303) arranged to vary the optical path of an incoming radiation beam in dependence on the polarization of the incoming radiation beam.

9. A device according to claim 8, wherein the index of refraction of the birefringent part varies in accordance with the polarization of radiation passing therethrough, and is arranged such that the optical wavefront modifier applies zero modification to the incident radiation beam.

10. A device according to claim 8, wherein the birefringent part comprises a liquid crystal material enclosed between optically homogeneous plates (301, 305).

11. A device according to claim 1, wherein the optical wavefront modifier is positioned in a substantially collimated portion of the incident radiation beam.

12. A device according to claim 1, including a polarisation-altering element (14A) located between the optical wavefront modifier and the optical record carrier, in the path of the incident and reflected radiation beams.

13. An optical wavefront modifier (10) for use in an optical scanning device (1) for scanning an optical record carrier (2) comprising an information layer (4), the device comprising
a radiation source (9) for emitting an incident radiation beam (7);
a detection system comprising an information signal detector (25) arranged to receive radiation reflected from the information layer and to detect an information signal therein;
an optical system (14, 12) for focusing the incident radiation beam to a spot on in the record carrier, and for directing the reflected radiation beam onto the information signal detector, wherein the optical wavefront modifier (10) is positionable in the path of the incident radiation beam and the reflected radiation beam such that the incident radiation beam has a first wavefront shape at a given location prior to its incidence on the optical wavefront modifier and the reflected radiation beam has a second wavefront shape at the said given location after passing through the optical wavefront modifier,
characterised in that the optical wavefront modifier is arranged to perform wavefront modification on the incident and reflected radiation beams such that the second wavefront shape is substantially different to the first wavefront shape.
